(19) United States
(12) Patent Application Publication
(10) Pub. No.: US 2019/0222720 A1
(43) Pub. Date: Jul. 18, 2019

(54) MULTIMEDIA SIGNAL SYNCHRONIZATION APPARATUS AND SYCHRONIZATION METHOD THEREOF

(71) Applicant: AVerMedia Technologies, Inc., New Taipei City (TW)

(72) Inventor: Hsiang-Yi Ma, New Taipei City (TW)

(21) Appl. No.: 16/232,196

(22) Filed: Dec. 26, 2018

(30) Foreign Application Priority Data
Jan. 12, 2018 (TW) 107101198

(51) Int. Cl. H04N 5/04

(52) U.S. Cl. CPC H04N 5/04

(57) ABSTRACT

A method for synchronizing multimedia signals includes a receiving process, a detecting process, a signal synchronization adjusting process and an output process. The receiving process receives a first multimedia signal and a second multimedia signal. The detecting process detects the time point of a first burst signal in the first multimedia signal and the time point of detecting a second burst signal in the second multimedia signal. The signal synchronization adjustment process adjusts the delay time of the first multimedia signal or the second multimedia signal. The output process outputs the adjusted first multimedia signal and the second multimedia signal after the adjustment.

### CROSS REFERENCE TO RELATED APPLICATIONS

This Non-provisional application claims priority under 35 U.S.C. § 119(a) on Patent Application No. 107101198 filed in Republic of China on Jan. 12, 2018, the entire contents of which are hereby incorporated by reference.

### BACKGROUND

### 1. Technical Field

The present invention relates to a synchronization apparatus and a synchronization method, in particular to a multimedia signal synchronization apparatus and a multimedia signal synchronization method.

### 2. Description of Related Art

With rapid development of technologies, a network bandwidth has been gradually increasing, and accordingly communication between people has been changing greatly from a single character and sound to an image. How to transmit high-quality audio-visual streaming efficiently is still the objective that people expect and pursue in nowadays.

People are increasingly broadcasting multimedia contents with different types of devices and software. For example, a desktop computer or a mobile communication device is used to watch a film and a video, download on demand or download the contents of streaming multimedia, or record and capture the contents (for example video chat or online meeting) of a(n) audio/video, etc., and these activities are ubiquitous in people's lives now.

In order to acquire better experiences when a user generates or consumes the multimedia contents, above all audio and video information in the multimedia contents should be synchronized. For example, if the user is implementing streaming broadcasting with a network camera and a radio device, video contents output by the network camera should be synchronized with audio contents output by the sound receiving device (for example, a mouth of the user should move together with words that the user is talking about in the aspect of time).

For example, when a video is intended to be synchronized with an audio by using a known multimedia signal synchronization method, a special sign should be respectively inserted into a video code and an audio code (for example, a black image is inserted into the video code, while a sound having a special frequency is inserted into the audio code). A play device may synchronously output the video and audio in accordance with the special sign. In the known synchronization method, the special sign must be added to an original signal. In other words, synchronization may not be implemented until the special sign is recognized by an audio-visual signal source and a rear playing device. Therefore, the known synchronization method is not applicable to the majority of playing occasions.

Therefore, how to provide a multimedia signal synchronization apparatus and a multimedia signal synchronization method is one of the important subjects at present. Herein, with the adoption of the multimedia signal synchronization apparatus and the multimedia signal synchronization method, multiple multimedia signals may be synchronously output, without needing a specific source or a specific apparatus.

### SUMMARY OF THE INVENTION

It is therefore an object of the present invention to provide a multimedia signal synchronization method, by which multiple multimedia signals may be synchronously output, without needing a specific source or a specific device.

To achieve the above, the present invention provides a multimedia signal synchronization method includes a multimedia signal receiving process, an emergency signal detecting process, a signal synchronization adjusting process and a multimedia signal output process. The multimedia signal receiving process receives a first multimedia signal and a second multimedia signal. The emergency signal detecting process detects a time point of a first emergency signal in the first multimedia signal, and the time point of a second emergency signal in the second multimedia signal. The signal synchronization adjusting process adjusts a delay time of the first multimedia signal or the second multimedia signal. The multimedia signal output process outputs the first multimedia signal and the second multimedia signal after adjustment.

In one embodiment of the present invention, wherein the first multimedia signal is generated by a first signal source, while the second multimedia signal is generated by a second signal source.

In another embodiment of the present invention, wherein the multimedia signal synchronization method further includes that the first signal source is required to generate the first multimedia signal with the first emergency signal, and the second signal source is required to generate the second multimedia signal with the second emergency signal at the same time.

In another embodiment of the present invention, wherein the signal synchronization adjusting process further includes that the time point of the first emergency signal is compared with that of the second emergency signal, and a later time point is configured as a synchronization datum point.

In another embodiment of the present invention, wherein the signal synchronization adjusting process, the delay time of the first multimedia signal or the second multimedia signal is adjusted, thereby making starting time points of the first multimedia signal and the second multimedia signal aligned in accordance with the synchronization datum point.

In addition, to achieve the above, the present invention provides a multimedia signal synchronization apparatus includes a multimedia signal receiving module, an emergency signal detecting module, a signal synchronization adjusting module and a multimedia signal output module. The multimedia signal receiving module receives a first multimedia signal and a second multimedia signal. The emergency signal detecting module detects a time point of a first emergency signal in the first multimedia signal, and the time point of a second emergency signal in the second multimedia signal. The signal synchronization adjusting module adjusts a delay time of the first multimedia signal or the second multimedia signal. The multimedia signal output module outputs the first multimedia signal and the second multimedia signal after adjustment.

In summary, with the adoption of the multimedia signal synchronization apparatus and the multimedia signal synchronization method of the present invention, all signal sources simultaneously generate one multimedia signal with the emergency signal, respectively. The time point of generating the emergency signal in the received multimedia signal is subsequently judged. On the basis of different causes, each of the multimedia signals may lead to different time delays. Therefore, the time point at which the emergency signal of the multimedia signal having the greatest time delay occurs is taken as the synchronization datum point when the time delay of each multimedia signal is detected, and output is implemented subsequently when all multimedia signals are aligned in accordance with the synchronization datum point. In this way, the multimedia signal synchronization apparatus and the multimedia signal synchronization method of the present invention do not need to any special sign to be added to an original signal, and accordingly the signal source and the device for subsequent processing and broadcasting are not required to have function of identifying the special sign.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

The parts in the drawings are not necessarily drawn to scale, the emphasis instead being placed upon clearly illustrating the principles of at least one embodiment. In the drawings, like reference numerals designate corresponding parts throughout the various diagrams, and all the diagrams are schematic.

FIG. 1 is a schematic diagram showing a multimedia signal synchronization apparatus in accordance with a preferred embodiment of the present invention.

FIG. 2 is a flow chart showing a multimedia signal synchronization method in accordance with a preferred embodiment of the present invention.

FIG. 3 is a flow chart showing the detailed multimedia signal synchronization method shown in FIG. 2.

### DETAILED DESCRIPTION

Reference will now be made to the drawings to describe various inventive embodiments of the present disclosure in detail, wherein like numerals refer to like elements throughout.

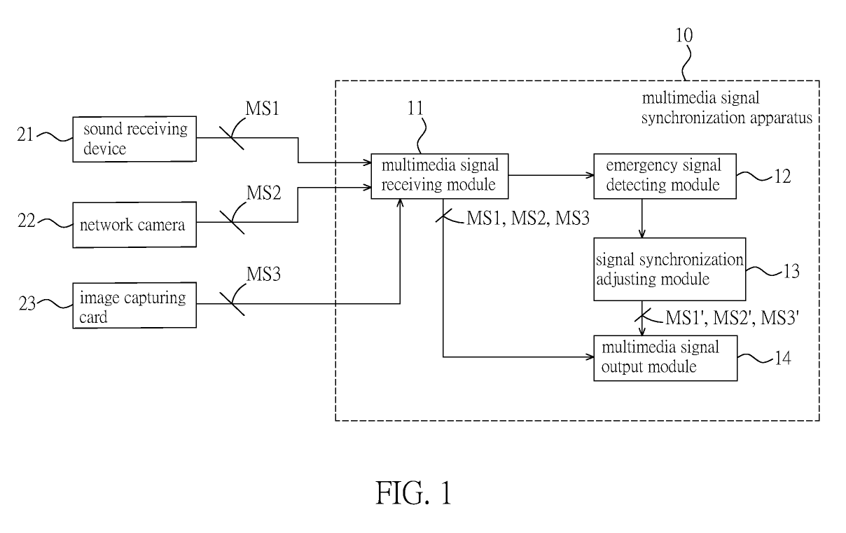

As shown in FIG. 1, a multimedia signal synchronization apparatus 10 of the present invention includes a multimedia signal receiving module 11, an emergency signal detecting module 12, a signal synchronization adjusting module 13 and a multimedia signal output module 14. Herein, the emergency signal detecting module 12 is coupled with the multimedia signal receiving module 11 and the signal synchronization adjusting module 13, respectively. The multimedia signal output module 14 is coupled with the signal synchronization adjusting module 13. In addition, three signal sources including a sound signal source, an image signal source and an audio signal source are used together with the multimedia signal synchronization apparatus 10. It is further described that the sound signal source, for example, is a sound receiving device 21, the image signal source is a network camera 22, and the audio signal source is a game screen which is captured by an image capturing card 23. Herein, the sound receiving device 21 outputs a first multimedia signal MS1, the network camera 22 outputs a second multimedia signal MS2, and the image capturing card 23 output a third multimedia signal MS3.

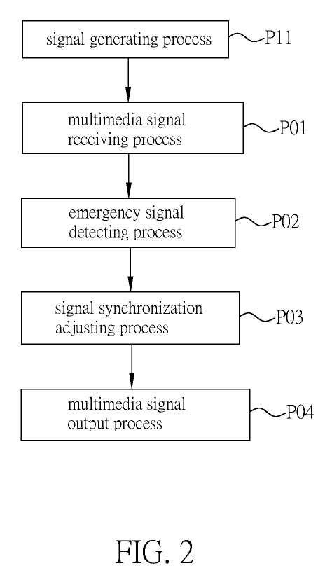

In combination with FIG. 2, a multimedia signal synchronization method in a preferred embodiment of the present invention includes a signal generating process P11, a multimedia signal receiving process P01, an emergency signal detecting process P02, a signal synchronization adjusting process P03 and a multimedia signal output process P04.

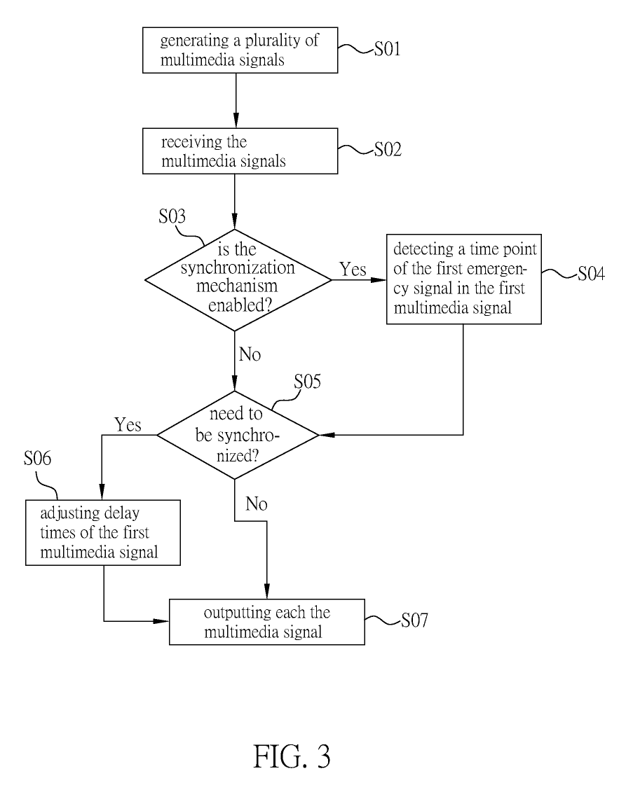

When using FIG. 3 for reference simultaneously, the signal generating process P11 includes a step S01 in which a sound receiving device 21 generates and outputs a first multimedia signal MS1, a network camera 22 generates and outputs a second multimedia signal MS2, and an image capturing card 23 generates and outputs a third multimedia signal MS3. Herein, the first multimedia signal MS1 is loaded with a first emergency signal, the second multimedia signal MS2 is loaded with a second emergency signal, and the third multimedia signal MS3 is loaded with a third emergency signal.

In the embodiment, one party that plans to implement synchronization requires three signal sources to simultaneously generate the first multimedia signal MS1, the second multimedia signal MS2 and the third multimedia signal MS3 with the emergency signals. While the so-called emergency signal, for example, is characterized in that a user faces the sound receiving device 21 to talk, faces the network camera 22 to wave hands and selects in a game screen popping up during playing a game to make the image capturing card 23 to capture an image. It is further described that the emergency signal, for example, is required to be generated during the 2nd second of each multimedia signal. The above-mentioned emergency signal is used as an example only, rather than intended to limit accordingly.

The multimedia signal receiving process P01 includes a step S02 in which a multimedia signal receiving module 11 receives the first multimedia signal MS1 having the first emergency signal, the second multimedia signal MS2 having the second emergency signal and the third multimedia signal MS3 having the third emergency signal.

In a Step S03, that whether the device enables a synchronization mechanism is judged. If the result is “Yes”, a step S04 may be implemented, or a step S05 may be implemented.

If the judgment result is “Yes”, the device enters into the emergency signal detecting process P02. The emergency signal detecting process P02 includes a step S04 of detecting a time point of the first emergency signal in the first multimedia signal MS1, the time point of the second emergency signal in the second multimedia signal MS2 and the time point of the third emergency signal in the third multimedia signal MS3.

Herein, it is to be noted that a signal transmission speed of each signal source may be different due to various causes, and accordingly a time delay of a signal may be generated. Therefore, the time points of the emergency signals which are detected here and generated simultaneously are inconsistent. For example, the time point of the first emergency signal in the first multimedia signal MS1 appears at 2.20 s, the time point of the second emergency signal in the second multimedia signal MS2 appears at 2.25 s, and the time point of the third emergency signal in the third multimedia signal MS3 appears at 2.40 s. From the example, the third multimedia signal MS3 has the longest delay time.

In addition, it is to be noted that when the emergency signal is one time point, for example, a surge as a result of talking of the user who faces the sound receiving device 21, the time point at which the surge occurs is judged as the time point of the emergency signal. While if the user faces the network camera 22 to wave hands, the emergency signal of a period of time is involved. At this time, a starting point of waving hands may be taken as the time point of judging the emergency signal.

If the judgment result of the step S03 is “No”, the step S05 may be implemented, to judge whether these multimedia signals need to be synchronized. If the result is “Yes”, a step S06 may be implemented, or a step S07 may be implemented.

If the judgment result is “Yes”, the device enters into the signal synchronization adjusting process P03. The signal synchronization adjusting process P03 includes a step S06 of adjusting delay times of the first multimedia signal MS1, the second multimedia signal MS2 and/or the third multimedia signal MS3. Seen from the above, the third emergency signal of the detected third multimedia signal MS3 has the longest delay time in the embodiment. Therefore, the time point of the third emergency signal of the third multimedia signal MS3 may be configured as a synchronization datum point. In other words, the first multimedia signal MS1 may be delayed for 0.2 s to be aligned with a starting point of the third multimedia signal MS3, while the second multimedia signal MS2 may be delayed for 0.15 s to be aligned with the starting point of the third multimedia signal MS3. In this way, transmission delay of the multimedia signals output by three signal sources may be corrected due to various causes.

Finally, the multimedia signal output process P04 includes a step S07 in which a multimedia signal synchronization apparatus 10 outputs the first multimedia signal, the second multimedia signal and the third multimedia signal. In the embodiment, the multimedia signal synchronization apparatus 10 may output a first multimedia signal MS1′, a second multimedia signal MS2′ and a third multimedia signal MS3′ with time delays adjusted when the step S07 is implemented after the step S06. However, the multimedia signal synchronization apparatus 10 may output the original first multimedia signal MS1, the original second multimedia signal MS2 and the original third multimedia signal MS3 when the step S07 is implemented after the step S05 because synchronization is not required in accordance with the judgment result.

All modules which are used in combination with the above-mentioned executive processes may be implemented with software as well, for example, an application software applicable to a computer, or a Mobile Application (APP) applicable to a mobile communication device. However, the software is used as the example only rather than intended to limit.

In conclusion, the multimedia signal synchronization apparatus and the multimedia signal synchronization method require all signal sources to simultaneously generate the multimedia signals with the emergency signals and accordingly confirm the delay time of each multimedia signal after judging and comparing the time points of all emergency signals. In this way, output times of all multimedia signals may be adjusted, to accordingly achieve synchronization. By means of the multimedia signal synchronization apparatus and the multimedia signal synchronization method provided by the present invention, it is not necessary to load a special sign to the multimedia signal, and accordingly the signal source and the device for subsequent processing and playing may still achieve the objective of synchronously outputting multiple multimedia signals, without having function of identifying the special sign.

Even though numerous characteristics and advantages of certain inventive embodiments have been set out in the foregoing description, together with details of the structures and functions of the embodiments, the disclosure is illustrative only. Changes may be made in detail, especially in matters of arrangement of parts, within the principles of the present disclosure to the full extent indicated by the broad general meaning of the terms in which the appended claims are expressed.

What is claimed is:

1. A multimedia signal synchronization method, comprising:
a multimedia signal receiving process receiving a first multimedia signal and a second multimedia signal;
an emergency signal detecting process detecting a time point of a first emergency signal in the first multimedia signal, and the time point of a second emergency signal in the second multimedia signal;
a signal synchronization adjusting process adjusting a delay time of the first multimedia signal or the second multimedia signal; and
a multimedia signal output process outputting the first multimedia signal and the second multimedia signal which are adjusted.

2. The multimedia signal synchronization method of claim 1, wherein the first multimedia signal is generated by a first signal source, and the second multimedia signal is generated by a second signal source.

3. The multimedia signal synchronization method of claim 2, further comprising:
requiring the first signal source to generate the first multimedia signal with the first emergency signal, and requiring the second signal source to generate the second multimedia signal with the second emergency signal at the same time.

4. The multimedia signal synchronization method of claim 1, wherein the signal synchronization adjusting process further comprising:
comparing the time point of the first emergency signal with the time point of the second emergency signal, wherein a later time point is configured as a synchronization datum point.

5. The multimedia signal synchronization method of claim 4, wherein during the signal synchronization adjusting process that the delay time of the first multimedia signal or the second multimedia signal is adjusted, thereby making starting time points of the first multimedia signal and the second multimedia signal aligned in accordance with the synchronization datum point.

6. A multimedia signal synchronization apparatus, comprising:
a multimedia signal receiving module, which receives a first multimedia signal and a second multimedia signal;
an emergency signal detecting module, which detects a time point of a first emergency signal in the first multimedia signal, and the time point of a second emergency signal in the second multimedia signal;
a signal synchronization adjusting module, which adjusts a delay time of the first multimedia signal or the second multimedia signal; and
a multimedia signal output module, which outputs the first multimedia signal and the second multimedia signal after adjustment.

7. The multimedia signal synchronization apparatus of claim 6, wherein the first multimedia signal is generated by a first signal source, and the second multimedia signal is generated by a second signal source.

8. The multimedia signal synchronization apparatus of claim 7, wherein a first signal source and a second signal source simultaneously generate the first multimedia signal with the first emergency signal and the second multimedia signal with the second emergency signal.

9. The multimedia signal synchronization apparatus of claim 6, wherein the signal synchronization adjusting module further compares the time point of the first emergency signal with that of the second emergency signal before adjusting the delay time of the first multimedia signal or the second multimedia signal, and configures a later time point as a synchronization datum point.

10. The multimedia signal synchronization apparatus of claim 9, in the signal synchronization adjusting module, the delay time of the first multimedia signal or the second multimedia signal is adjusted, thereby making starting time points of the first multimedia signal and the second multimedia signal aligned in accordance with the synchronization datum point.
